(19) United States
(12) Patent Application Publication
(10) Pub. No.: US 2008/0283604 A1
(43) Pub. Date: Nov. 20, 2008

(54) DRIVING CONTROL OF SCANNING DEVICE

(75) Inventors: Gi-Young Byun, Incheon (KR); Joo-Hong Kim, Hwaseong-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/101,842

(22) Filed: Apr. 11, 2008

(30) Foreign Application Priority Data
May 16, 2007 (KR) 10-2007-0047736

(51) Int. Cl. G06K 7/10

(52) U.S. Cl. 235/454

(57) ABSTRACT

Disclosed are an apparatus for controlling a driving of a scanning device included in a scanning display apparatus and a method thereof. The apparatus for controlling a driving of the scanning device can include a sensing unit, sensing an operation status of the scanning device and outputting a sensing signal corresponding to the operation status; a sensing signal determining unit, determining whether the sensing signal is within a predetermined range; a mode selecting unit, selecting an open loop mode or a close loop mode according to a result determined by the sensing signal determining unit; and a processing unit, controlling the driving of the scanning device by outputting a driving signal according to the selected mode.

### CROSS-REFERENCE TO RELATED PATENT APPLICATIONS

This application claims the benefit of Korean Patent Application No. 10-2007-0047736, filed on May 16, 2007, in the Korean Intellectual Property Office, the disclosure of which is incorporated herein in its entirety by reference.

### BACKGROUND OF THE INVENTION

1. Field of the Invention

The present invention relates to a scanning display apparatus, more specifically to a method for controlling the driving of a scanning device included in a scanning display apparatus

2. Background Art

While a conventional digital information processing method is impossible to process a large amount of data in real-time, an optical signal processing method can generally perform high-speed processing, parallel processing and large data amount processing. Also, studies on designs and manufactures of a binary phase filter, an optical logic gate, a light amplifier, a photoelectric element and an optical modulator by applying a spatial light modulation method are being developed. Particularly, the optical modulator is used in an optical memory, a light display, a printer, an optical interconnection and a hologram. A light beam scanning device using the optical modulator is being developed.

The light beam scanning device functions as forming a picture image by scanning a light beam in an image forming device such as a laser printer, an LED printer, an electronic photocopier, a word processor and a projector and spotting the light beam on a photosensitive medium.

As a projection television has been recently developed, an optical modulator and a light beam scanning device are being used as means that scans a light beam on a screen.

FIG. 1 illustrates a simple structure of a scanning display apparatus using a scanning device. Referring to FIG. 1, the scanning display apparatus includes a light source 110, a scanning device 120, a screen 130 and a processing unit 140.

The light source 110 emits a linear beam of light. The linear beam of light is scanned on the screen 130 through the scanning device 120. The linear beam of light emitted from the light source 110 includes image information by an optical modulator and is converted to a two-dimensional image to be displayed on the screen 130 by the rotation of the scanning device 120.

The processing unit 140 controls the output of the linear beam of light emitted from the light source 110 and the driving of the scanning device 120. The processing unit 140 synchronizes the output of the linear beam of light emitted from the light source 110 with the rotation of the scanning device 120 such that the linear beam of light emitted from the light source 110 can be projected on a predetermined portion of the screen 130 by the scanning device 120.

The scanning device 120 of FIG. 1 is assumed to be a galvano mirror type. The scanning device 120 includes a motor (not shown) capable of rotating in two directions. The scanning device 120 is rotated in a predetermined direction by the motor according to a driving signal transferred from the processing unit 140 in order to reflect the linear beam of light emitted from the light source 110 in the direction of the screen 130.

The scanning device 120 of FIG. 1 is controlled by an open loop method. The processing unit 140 can simplify and optimize the general structure of hardware by outputting a driving signal optimized for the dynamic characteristic of the scanning device 120 to drive the scanning device 120. However, it is difficult to deal with an external damage and the deviation of the dynamic characteristic of the scanning device 120.

FIG. 2 illustrates a simple structure of a scanning display apparatus that controls a scanning device in a close loop method.

The scanning display apparatus illustrated in FIG. 2 includes a scanning device 220, a processing unit 240, a sensing unit 260 and an error correcting unit 280. Here, even through a light source and a screen are not shown in FIG. 2, the scanning display apparatus of FIG. 2 is assumed to further include the light source and the screen like the scanning display apparatus illustrated in FIG. 1.

The scanning display apparatus illustrated in FIG. 2 is controlled by a close loop method. The close loop, which is required to include additional hardware such as the sensing unit 260 and the error correcting unit 280 or software for the feedback control, can solve the problem generated in the driving control using the open loop method. In other words, it is possible to correct an error according to an abnormal operation. Further, if the sensing unit is broken or uncontrollable information is inputted, the processing unit 240 is unable to generate an optimized driving signal. This causes the control of the scanning device 120 to be impossible.

### SUMMARY OF THE INVENTION

Accordingly, the present invention provides a method for controlling the driving of a scanning device and an apparatus thereof that can maintain the driving stably by changing a close loop method to an open loop method if a sensing unit is broken or uncontrollable information is inputted in the driving control using the close loop method.

The present invention also provides a method for controlling the driving of a scanning device and an apparatus thereof that can prevent a scanning device from being broken and allow a user to select and use a close loop method and an open loop method.

An aspect of the present invention features an apparatus for controlling a driving of a scanning device that can use either an open loop mode or a close loop mode.

According to an embodiment of the present invention, the apparatus for controlling the driving of a scanning device can include a sensing unit, sensing an operation status of the scanning device and outputting a sensing signal corresponding to the operation status; a sensing signal determining unit, determining whether the sensing signal is within a predetermined range; a mode selecting unit, selecting an open loop mode or a close loop mode according to a result determined by the sensing signal determining unit; and a processing unit, controlling the driving of the scanning device by outputting a driving signal according to the selected mode.

The processing unit can include an open loop signal generating unit, generating an open loop driving signal; an error correcting unit, computing an error of the operation status of the scanning device from the sensing signal, and outputting a correcting signal corresponding to the error; and a close loop signal generating unit, generating a close loop driving signal feedback-controlled based on the correcting signal.

If the open loop mode is selected, the mode selecting unit can activate the open loop signal generating unit and inactivate the close loop signal generating unit, and if the close loop mode is selected, the mode selecting mode can activate the close loop signal generating unit and inactivate the open loop signal generating unit.

Alternatively, the mode selecting unit can allow the processing unit to output any one of the open loop driving signal and the close loop driving signal to the scanning device. Here, the outputted driving signal can correspond to the selected mode.

Alternatively, the mode selecting unit can further include a switch between the error correcting unit and the close loop signal generating unit. At this time, the mode selecting unit can turn off the switch if the open loop mode is selected and can turn on the switch if the close loop mode is selected. Here, if the close loop signal generating unit is connected to the error correcting unit, the close loop signal generating unit can generate the close loop driving signal.

Further, the apparatus can further include an external selection input unit, receiving a selection of any one of the open loop mode or the close loop mode and outputting an external selecting signal corresponding to the received selection to the sensing signal determining unit. Here, if the sensing signal and the external selection signal are inputted, the sensing signal determining unit can give a priority to the external selection signal.

An aspect of the present invention features a method for controlling a driving of a scanning device that can use either an open loop mode or a close loop mode.

According to an embodiment of the present invention, the method for controlling the driving of a scanning device can include sensing an operation status of the scanning device; outputting a sensing signal corresponding to the operation status; determining whether the sensing signal is within a predetermined range; selecting an open loop mode or a close loop mode according to a determined result; and controlling the driving of the scanning device by outputting a driving signal according to the selected mode.

Here, the controlling step can include generating an open loop driving signal, if the open loop mode is selected; and computing an error of the operation status of the scanning device from the sensing signal; and outputting a correcting signal corresponding to the error, if the close loop mode is selected. Here, a close loop driving signal feedback-controlled based on the correcting signal can be generated.

Alternatively, the controlling step can include generating an open loop driving signal; and computing an error of the operation status of the scanning device from the sensing signal, outputting a correcting signal corresponding to the error and generating a close loop driving signal feedback-controlled based on the correcting signal. Here, the open loop driving signal can be outputted if the open loop selecting mode is selected, and the close loop driving signal can be outputted if the close loop selecting mode is selected

The method can further include determining whether an external selection signal is inputted after the step of outputting the sensing signal. Here, if the external selecting signal is inputted, the open loop mode or the close loop mode can be selected according to a corresponding external selection, and if the external selecting signal is not inputted, whether the sensing signal is within a predetermined range can be determined.

### BRIEF DESCRIPTION OF THE DRAWINGS

These and other features, aspects and advantages of the present invention will become better understood with regard to the following description, appended Claims and accompanying drawings where:

FIG. 1 illustrates a simple structure of a scanning display apparatus using a scanning device;

FIG. 2 illustrates a simple structure of a scanning display apparatus that controls a scanning device in a close loop method;

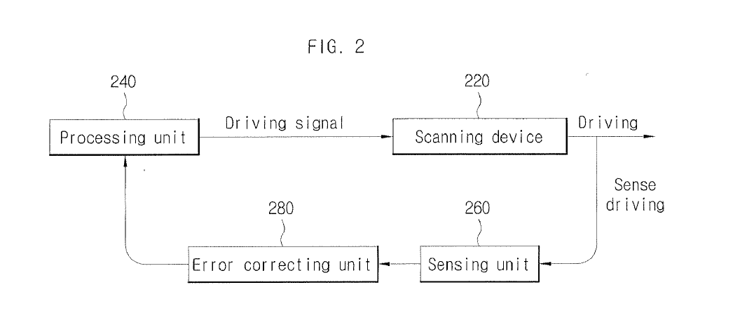

FIG. 3 illustrates a simple structure of an apparatus for controlling the driving of a scanning device in accordance with an embodiment of the present invention;

FIG. 4 is a graph of a sensing signal showing the operation status of a scanning device in accordance with an embodiment of the present invention; and

FIG. 5 is a flow chart illustrating a method for controlling the driving of a scanning device in accordance with an embodiment of the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of the present invention will be described in detail with reference to the accompanying drawings.

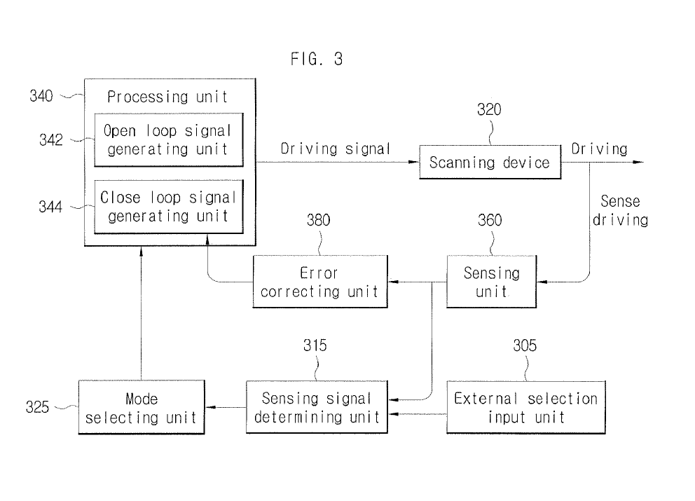

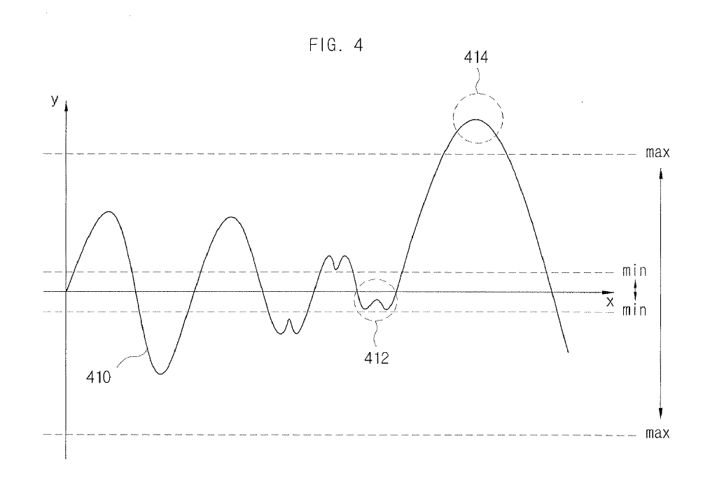

FIG. 3 illustrates a simple structure of an apparatus for controlling the driving of a scanning device in accordance with an embodiment of the present invention, and FIG. 4 is a graph of a sensing signal showing the operation status of a scanning device in accordance with an embodiment of the present invention.

The apparatus for controlling the driving of the scanning device can include a processing unit 340, a correcting unit 380, a sensing signal determining unit 315 and a mode selecting unit 325. The apparatus for controlling the driving of the scanning device can further include an external selection input unit 305.

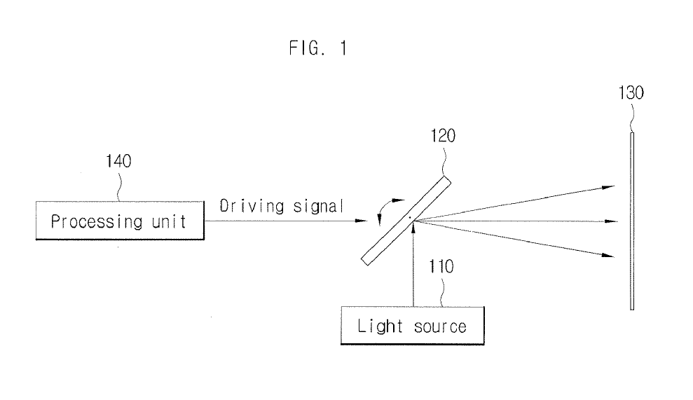

The scanning device 320 can reflect a linear beam of light emitted from a light source (not shown) to a screen (not shown). Here, the light source and the screen can perform the same functions as those of FIG. 1. In this case, the scanning device 320 can rotate on a rotation axis in a predetermined direction in order to reflect the linear beam of light emitted from the light source to a corresponding portion of the screen. In case that the scanning device 320 performs the scanning in a single direction like a polygon mirror, the scanning device 320 can rotate on the rotation axis in a clockwise or counterclockwise direction. In case that the scanning device 320 performs the scanning in a two-direction direction like a galvano mirror, the scanning device 320 can repeatedly rotate on the rotation axis in the clockwise direction before rotating in the counterclockwise direction, for example.

The rotating operation of the scanning device 320 can be performed by the apparatus for controlling the driving of the scanning device. In particular, the rotating operation of the scanning device 320 can be performed according to a driving signal transferred from the processing unit 340 of the apparatus for controlling the driving of the scanning device. If the linear beam of light emitted from the light source can be incident to the scanning device 320, the processing unit can generate and output a driving signal synchronizing the operation of the light source with the operation of the scanning device 320 in order to allow the linear beam of light to be reflected to a desired portion of the screen.

Herein, the processing unit 340 can include an open loop signal generating unit 342 and a close loop signal generating unit 344. The open loop signal generating unit 342 can generate an open loop driving signal according to the predetermination in accordance with the driving characteristic of the scanning device 320. The close loop signal generating unit 344 can generate a close loop driving signal feedback-controlling the current operation of the scanning device 320.

The processing unit 340 can select any one of the open loop driving signal generated by the open loop generating unit 342 and the close loop driving signal generated by the close loop generating unit 344 and output the selected driving signal to the scanning device 320 in order to control the operation of the scanning device 320.

The sensing unit 360 can sense the driving of the scanning device 320 controlled according to the driving signal. Herein, the sensing unit 360 can be configured to include an optical sensor, a hall sensor, and/or a capacitive sensor (e.g. varicon). Each sensor can sense a current operation status of the scanning device 320 and output a corresponding sensing signal by allowing a pertinent output value to be changed according to the rotation of the scanning device 320.

Here, the sensing signal can be sensed by a method of recognizing a voltage or a current or a method of detecting a designated frequency. The optical sensor can refer to the device that converts the change of the quantity of light or position information of an incident beam of light to an electrical signal. The hall sensor can refer to the device that converts the change of magnetic forces to an electrical signal. The capacitive sensor can refer to the device that converts the change of condenser capacity to an electrical signal.

The error correcting unit 380 can compare the driving signal outputted from the processing unit 340 with the sensing signal outputted from the sensing unit 360 and correct an error in order to allow the scanning device 302 to perform a desired operation corresponding to the driving signal. For example, if the error correcting unit 380 recognizes that the scanning device 320 was supposed to rotate as much as A in a predetermined direction according to the driving signal outputted from the processing unit 340 but recognize that the scanning device 320 has rotated as much as B according to the driving signal outputted from the sensing unit 360, the error correcting unit 380 can output a correcting signal corresponding to the difference between A and B.

The processing unit 340 can correct the driving signal based on the outputted correcting signal. Then, when it is required to output the driving signal controlling the driving of the scanning device 320, the processing unit 340 can output the driving signal corrected based on the correcting signal.

The sensing signal determining unit 315 can receive the sensing signal outputted from the sensing unit 360. Then, the sensing signal determining unit 315 can determine whether a value corresponding to the inputted sensing signal is within the range which is required for the feedback control or the close loop control.

The sensing signal determining unit 315 can predetermine the range which is required for the feedback control. Referring to FIG. 4, the graph showing the magnitude of the sensing signal (i.e. y-axis) according to the elapse of time (i.e. x-axis) is illustrated.

The range which is required for the feedback control can be between the lower threshold (i.e. min of FIG. 4) and the upper threshold (i.e. max of FIG. 4). If the magnitude of the sensing signal is between the upper threshold and the lower threshold, the close loop mode is selected for the driving control method of the scanning device 320. If the magnitude of the sensing signal is beyond the upper threshold or the lower threshold, the open loop mode is selected.

If the magnitude of the sensing signal is beyond the upper threshold or the lower threshold (e.g. a portion 412 or 414 of FIG. 4), the driving control using the close loop method is impossible due to the broken sensing unit 360, the bad sensing status of the sensing unit 360 caused by a foreign material or a blocking material and/or malfunction of the sensing unit 360.

The mode selecting mode 325 can select the open loop mode or close loop mode according to the result determined by the sensing signal determining unit 315. The processing unit 340 can allow a driving signal corresponding to the mode selected by the mode selecting unit 325 to be outputted to the scanning device 320.

The processing unit 340 can include the open loop signal generating unit 342 and the close loop signal generating unit 344. In accordance with an embodiment of the present invention, the open loop signal generating unit 342 and the close loop signal generating unit 344 can generate the open loop driving signal and the close loop driving signal, respectively. The driving signal corresponding to the mode selected by the mode selecting unit 325 can be outputted to the scanning device 320.

In accordance with another embodiment of the present invention, the signal generating unit 342 or 344 corresponding to the mode selected by the mode selecting unit 325 can be activated. The activated signal generating unit 342 or 344 can generate the corresponding driving signal and output the generated driving signal to the scanning device 320. For example, if the open loop mode is selected by the mode selecting unit 325, the open loop signal generating unit 342 can be activated and the close loop signal generating unit 344 may be inactivated. As a result, the open loop driving signal can be generated and outputted to the scanning device 320. In the meantime, if the close loop mode is selected by the mode selecting unit 325, the open loop signal generating unit 342 may be inactivated and the close loop signal generating unit 344 can be activated. As a result, the close loop driving signal can be generated and outputted to the scanning device 320.

Here, a switch can be placed between the error correcting unit and the close loop signal generating unit. At this time, the mode selecting unit can turn off the switch if the open loop mode is selected and turn on the switch if the close loop mode is selected. In particular, the mode selecting unit 325 can be realized as a switch. The switch can be placed between the error correcting unit 380 and the close loop signal generating unit 344 in order to connect or disconnect the error correcting unit 380 to the close loop signal generating unit 344. As the result determined by the sensing signal determining unit 315, if the sensing signal is within the range between the lower threshold and the upper threshold, the switch can be turned on in order to allow the close loop signal generating unit 344 to generate the close loop driving signal by using a value outputted from the error correcting unit 380. If the sensing signal is beyond the range between the lower threshold and the upper threshold, the switch may be turned off. As a result, since the close loop signal generating unit 344 receives no value outputted from the error correcting unit 380, no close loop driving signal may be generated.

Here, if the close loop signal generating unit 344 is not connected to the error correcting unit 380, the close loop signal generating unit 344 may be inactivated, to thereby generate no close loop driving signal. If the close loop signal generating unit 344 is connected to the error correcting unit 380, the close loop signal generating unit 344 may be activated, to thereby generate the close loop driving signal.

Alternatively, the mode selecting mode 325 can be connected to the open loop signal generating unit 342 and the close loop signal generating unit 344, respectively. If the open loop mode is selected, the mode selecting unit 325 can output a signal allowing the open loop signal generating unit 342 to be activated and the close loop signal generating unit 344 to be inactivated. If the close loop mode is selected, the mode selecting unit 325 can output a signal allowing the open loop signal generating unit 342 to be inactivated and the close loop signal generating unit 344 to be activated.

The processing unit 340 can control the driving of the scanning device 320 by outputting a driving signal, generated by any one of the open loop signal generating unit 342 and the close loop generating unit 344, to the scanning device 320.

Alternatively, the mode selecting unit 325 can be connected to the processing unit 340 in order to allow the driving signal corresponding to the selected mode among the open loop driving signal generated by the open loop signal generating unit 342 and the close loop driving signal generated by the close loop signal generating unit 344 to be outputted to the scanning device 320.

In accordance with another embodiment of the present invention, the apparatus for controlling the driving of the scanning device 320 can further include the external selection input unit 305. The external selection input unit 305 can receive the selection of any one of the open loop method and the close loop method. Then, the sensing signal determining unit 315 can select the open loop method or the close loop method according to an external selection signal transferred from the external selection input unit 305.

The sensing signal determining unit 315 can receive the sensing signal from the sensing unit 360 and the external selection signal from the external selection input unit 305. In the case of receiving both the sensing signal and the external selection signal, the priority can be given to the external selection signal transferred from the external selection input unit 305 in order to allow a user to select any one of the open loop method and the close loop method.

In accordance with the present invention, the apparatus for controlling the driving of the scanning device can be operated in the close loop method as the default and can be changed into the open loop method according to the result determined by the sensing signal determining unit 315. In particular, the apparatus for controlling the driving of the scanning device can be changed into the open loop method by a user or due to the breakdown of the sensing unit 360 or the input of the uncontrollable sensing signal.

Using the open loop method together with the close loop method makes it to possible to more preciously and stably control the driving of the scanning device 320 as compared with using the open loop method or the close loop method separately. In case that the sensing unit 360 was unable to accurately sense the operation status of the scanning device 320 due to the breakdown of the sensing unit 360 or the input of the uncontrollable sensing signal, the driving control mode can be changed into the open loop method. The driving of the scanning device 320 can be controlled by using the open loop driving signal generated by the open loop signal generating unit 342. The apparatus for controlling the driving of the scanning device can be operated in the open loop method instead of the close loop method until the aforementioned problem is solved.

It is possible to prevent the scanning device 320 from being broken or damaged and enhance the durability of the scanning device 320 by sensing and suitably dealing with the abnormal operation of the scanning device 320 caused by an external damage.

In the present invention, the open loop generating unit 342 can generate the open loop driving signal according to a predetermined dynamic characteristic of the scanning device 320 or the open loop driving signal corrected by using the correcting signal to which the driving characters of the scanning device 320 is applied by the error correcting unit 380 before the sensing unit 360 sense the abnormal operation.

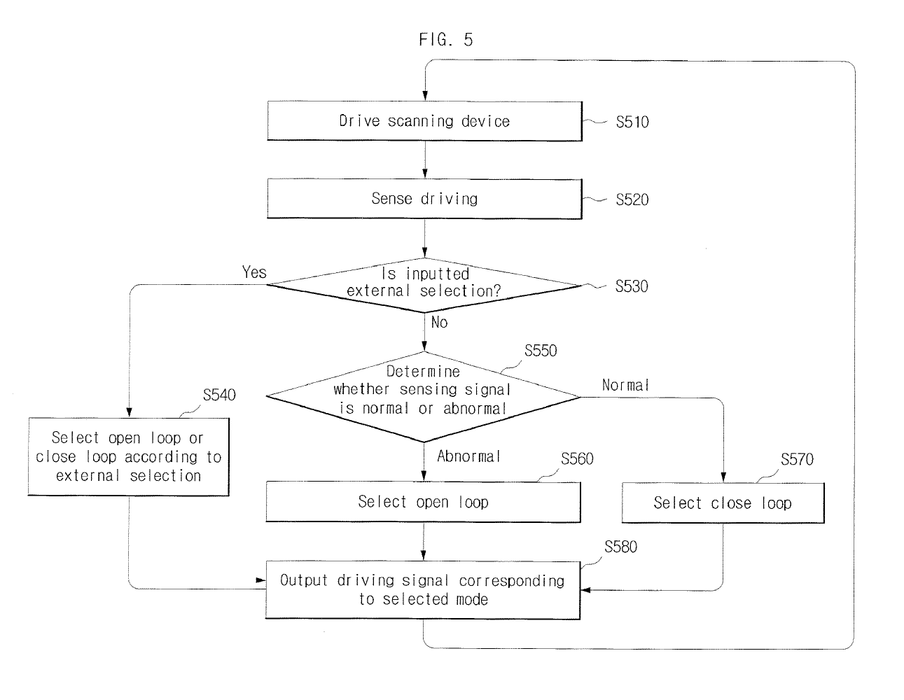

Hereinafter, the method for controlling the driving of a scanning device of the present invention will be described in detail. FIG. 5 is a flow chart illustrating a method for controlling the driving of a scanning device in accordance with an embodiment of the present invention.

In a step represented by S510, the processing unit 340 of an apparatus for controlling the drive of a scanning device can output a driving signal to drive the scanning device 320. In a step represented by S520, the sensing unit 360 can sense the driving of the scanning device 320 and output a corresponding sensing signal.

In case that the apparatus for controlling the drive of the scanning device further includes the external selection input unit 305, in a step represented by S530, the sensing signal determining unit 315 can determine whether an external selection signal is inputted. In case that the external selection signal is inputted, the operation proceeds to a step represented by S540 in which the mode selecting unit 325 can select an open loop mode or a close loop mode according to the external selection.

The steps represented by S530 and S540 can be performed in case that the apparatus for controlling the drive of the scanning device further includes the external selection input unit 305. If the apparatus for controlling the drive of the scanning device includes no external selection input unit 305, the steps will be omitted.

In this case, the step represented by S520 can proceed to a step represented by S550 in which the sensing signal determining unit 315 can determine whether the sensing signal outputted from the sensing unit 360 is abnormal. Here, the case that the sensing signal is within a predetermined range can be represented as “normal” and the case that the sensing signal is beyond the predetermined range can be represented as “abnormal.”

As the result determined by the sensing signal determining unit 315, in case it is determined that the sensing signal is normal, which is within the predetermined range, the operation can proceed to a step represented by S570 in which the mode selecting unit 325 can select the close loop mode or if the close loop mode has been already selected, maintain the selected close loop mode.

As the result determined by the sensing signal determining unit 315, in case it is determined that the sensing signal is abnormal, which is beyond the predetermined range, the operation can proceed to a step represented by S560 in which the mode selecting unit 325 can select the open loop mode or if the open loop mode has been already selected, maintain the selected open loop mode.

A step represented by S580 can generate and output an open or close loop driving signal according to the mode selected in the step represented by S540, S560 or S570.

The operation can return to the step represented by S510, to thereby drive the scanning device 320. The steps represented by S520 through S580 can be repeatedly performed.

In another embodiment of the present invention, in case that the open loop mode is selected in the step represented by S580, the open loop mode can be determined to output the open loop driving signal to the scanning device 320 later.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. An apparatus for controlling a driving of a scanning device, the apparatus comprising:
a sensing unit, sensing an operation status of the scanning device and outputting a sensing signal corresponding to the operation status;
a sensing signal determining unit, determining whether the sensing signal is within a predetermined range;
a mode selecting unit, selecting an open loop mode or a close loop mode according to a result determined by the sensing signal determining unit; and
a processing unit, controlling the driving of the scanning device by outputting a driving signal according to the selected mode.

2. The apparatus of claim 1, wherein the processing unit comprises:
an open loop signal generating unit, generating an open loop driving signal;
an error correcting unit, computing an error of the operation status of the scanning device from the sensing signal, and outputting a correcting signal corresponding to the error; and
a close loop signal generating unit, generating a close loop driving signal feedback-controlled based on the correcting signal.

3. The apparatus of claim 2, wherein, if the open loop mode is selected, the mode selecting unit activates the open loop signal generating unit and inactivates the close loop signal generating unit, and if the close loop mode is selected, the mode selecting mode activates the close loop signal generating unit and inactivates the open loop signal generating unit.

4. The apparatus of claim 2, wherein the mode selecting unit allows the processing unit to output any one of the open loop driving signal and the close loop driving signal to the scanning device, the outputted driving signal corresponding to the selected mode.

5. The apparatus of claim 2, further comprising: a switch between the error correcting unit and the close loop signal generating unit, whereas the mode selecting unit turns off the switch if the open loop mode is selected and turns on the switch if the close loop mode is selected.

6. The apparatus of claim 5, wherein, if the close loop signal generating unit is connected to the error correcting unit, the close loop signal generating unit generates the close loop driving signal.

7. The apparatus of claim 1, further comprising an external selection input unit, receiving a selection of any one of the open loop mode or the close loop mode and outputting an external selecting signal corresponding to the received selection to the sensing signal determining unit.

8. The apparatus of claim 7, wherein, if the sensing signal and the external selection signal are inputted, the sensing signal determining unit gives a priority to the external selection signal.

9. A method for controlling a driving of a scanning device, the method comprising:
sensing an operation status of the scanning device;
outputting a sensing signal corresponding to the operation status;
determining whether the sensing signal is within a predetermined range;
selecting an open loop mode or a close loop mode according to a determined result; and
controlling the driving of the scanning device by outputting a driving signal according to the selected mode.

10. The method of claim 9, wherein the controlling step comprises:
generating an open loop driving signal, if the open loop mode is selected; and
computing an error of the operation status of the scanning device from the sensing signal; and outputting a correcting signal corresponding to the error, if the close loop mode is selected,
whereas a close loop driving signal feedback-controlled based on the correcting signal is generated.

11. The method of claim 9, wherein the controlling step comprises:
generating an open loop driving signal; and
computing an error of the operation status of the scanning device from the sensing signal, outputting a correcting signal corresponding to the error and generating a close loop driving signal feedback-controlled based on the correcting signal, whereas the open loop driving signal is outputted if the open loop selecting mode is selected, and the close loop driving signal is outputted if the close loop selecting mode is selected.

12. The method of claim 9, further comprising: determining whether an external selection signal is inputted after the step of outputting the sensing signal,
whereas if the external selecting signal is inputted, the open loop mode or the close loop mode is selected according to a corresponding external selection, and if the external selecting signal is not inputted, whether the sensing signal is within a predetermined range is determined.
